(19) United States
(12) Patent Application Publication
(10) Pub. No.: US 2013/0150783 A1
(43) Pub. Date: Jun. 13, 2013

(54) CUP FOR DISPENSING MEDICINE

(71) Applicant: Agathonicos George Pamboukis, Massillon, OH (US)

(72) Inventor: Agathonicos George Pamboukis, Massillon, OH (US)

(21) Appl. No.: 13/713,057

(22) Filed: Dec. 13, 2012

Related U.S. Application Data
(60) Provisional application No. 61/569,951, filed on Dec. 13, 2011.

(51) Int. Cl. A61J 7/00; G01F 19/00

(52) U.S. Cl. CPC A61J 7/0046; A61J 7/0038; G01F 19/00
USPC 604/78

(57) ABSTRACT

Methods, cups and other embodiments associated with consuming a beverage with a medicine are presented. A cup for consuming a liquid and a medicine comprises a main cup body, a cup base and a straw. The main cup body is adapted to receive a liquid beverage. The cup base is adapted for receiving a liquid medicine. The cup base is adapted to be removed from the cup main cup body for adding the liquid medicine to the cup base. The cup base is further adapted to be attached to the main cup body after the liquid medicine is added to the cup base. The straw has a beverage opening and a medicine opening. The medicine opening is adapted to be placed in the cup base for extracting the liquid medicine and the beverage opening is adapted to be placed in the main cup body for extracting the liquid beverage.

### CROSS REFERENCE TO RELATED APPLICATION

This application claims priority from U.S. Provisional Application Ser. No. 61/569,951, filed Dec. 13, 2011; the disclosure of which is incorporated herein by reference.

### BACKGROUND OF THE INVENTION

1. Technical Field

The present invention relates generally to systems and methods for consuming liquids. More particularly, the systems and methods relate to consuming liquids with a cup. Specifically, the methods and systems of the present invention involve a cup with the ability to measure an amount of medicine consumed with a liquid in the cup.

2. Background Information

Training cups (e.g., sippy cups) are used to help transition babies from bottles to regular cups. Typically, the biggest challenge in transitioning babies from bottles to regular cups is teaching them to not dump the fluid all over themselves by tipping the cup as far back as when using a bottle, to which they have come accustomed, to empty the cup.

Administering liquid medicine to toddlers can also be challenging. Because some medicines do not taste well to children it can be difficult for them to directly orally ingest the medicine. If the medicine is first mixed with a liquid such as a juice drink and consumed with a training cup, it can be difficult to know how much medicine has been consumed if not all the liquid is consumed.

Training cups usually come in two varieties, a cup with lid and spout (sippy cup) to drink while tilted towards the mouth, or a cup with lid and straw to drink by sucking through the straw. One problem with the straw cup is it does not train the baby's motor skill habits to handle a regular cup. On the other hand, with the lid and spout training cup, the baby will usually tip the cup almost completely upside down and thus need to tip his or her head back to finish the fluid. This creates discomfort for the baby, and also provides no training for transition to using regular adult-type cups. A better cup for drinking liquids is desired.

### SUMMARY

The preferred embodiment of the invention includes a cup for consuming a liquid and a medicine. The cup for consuming a liquid and a medicine includes a main cup body, a cup base and a straw. The main cup body is adapted to receive a liquid beverage. The cup base is adapted for receiving a liquid medicine. The cup base can be removed from the main cup body before adding the liquid medicine to the cup base and it can then be reattached to the main cup body after the liquid medicine is added to the cup base. The straw has a beverage opening and a medicine opening. The medicine opening can be placed in the cup base for extracting the liquid medicine and the beverage opening can be placed in the main cup body for extracting the liquid beverage.

Other configurations of the preferred embodiment can include other items and other useful features. For example, the cup can include a lid that can be attached to the cup. The lid has a hole for passing the straw through the lid. The cup base can have graduated markings for determining how much liquid medicine is in the cup base. The cup base can include a top wall and a bottom wall. A hole in the top wall allows a portion of the straw with the medicine opening to fit through the hole in the top wall. The bottom wall can be tapered for allowing medicine in the cup base to flow toward the straw. Additionally, the main cup body can include a bottom wall with a hole in it for receiving the straw. The hole can be sealed with a one-way valve.

In some configurations of the preferred embodiment, the straw can be formed with various components. For example, the straw can include a medicine shaft with a first end and a second end where the medicine opening is formed at the second end of the medicine shaft. The straw can likewise include a beverage shaft with a first end and a second end where the beverage opening is formed at the second end of the beverage shaft. The medicine shaft and the main shaft can combine/intersect at the bottom of a main shaft that extends out the top of the cup. In the preferred embodiment, the area of the beverage opening is at least twice the size of the of the medicine opening.

A second embodiment is a training cup for administering medicine. The cup includes a main cup portion that has a lower chamber for receiving medicine and an upper chamber for receiving a beverage. The training cup can have a curved wall between the upper chamber and the lower chamber so that the medicine poured into the training cup flows from the upper chamber to the lower chamber. Graduated markings can be placed on the cup to indicate how much medicine is in the lower chamber. The training cup has a lid attachable to the main cup portion. The lid includes a one-way valve to prevent the spillage of liquid from the training cup. In one configuration of this embodiment, one or more handles sized to allow a toddler to easily handle the training cup can be included on the training cup.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates the preferred embodiment of a cup for consuming a liquid and a medicine.

FIG. 2 illustrates a cross-sectional and exploded view of the preferred embodiment of a cup for consuming a liquid and a medicine.

FIG. 3 illustrates a cross-sectional assembled view of the preferred embodiment of a cup for consuming a liquid and a medicine.

FIG. 4 illustrates a cross-sectional exploded view of a second configuration of the preferred embodiment of a cup for consuming a liquid and a medicine.

FIG. 5 illustrates a cross-sectional assembled view of the second configuration of the preferred embodiment of a cup for consuming a liquid and a medicine.

FIG. 6 illustrates a cross-sectional exploded view of a third configuration of the preferred embodiment of a cup for consuming a liquid and a medicine.

FIG. 7 illustrates a cross-sectional assembled view of the third configuration of the preferred embodiment of a cup for consuming a liquid and a medicine.

FIG. 8 illustrates another example straw that is generally formed as a straw within a straw that can be used to consume two different liquids at the same time.

FIG. 9 illustrates and example training cup with a chamber for medicine formed in the lid of the cup.

FIG. 10 illustrates a configuration of the preferred embodiment as a method of using a cup for dispensing medicine.

Similar numbers refer to similar parts throughout the drawings.

### DETAILED DESCRIPTION

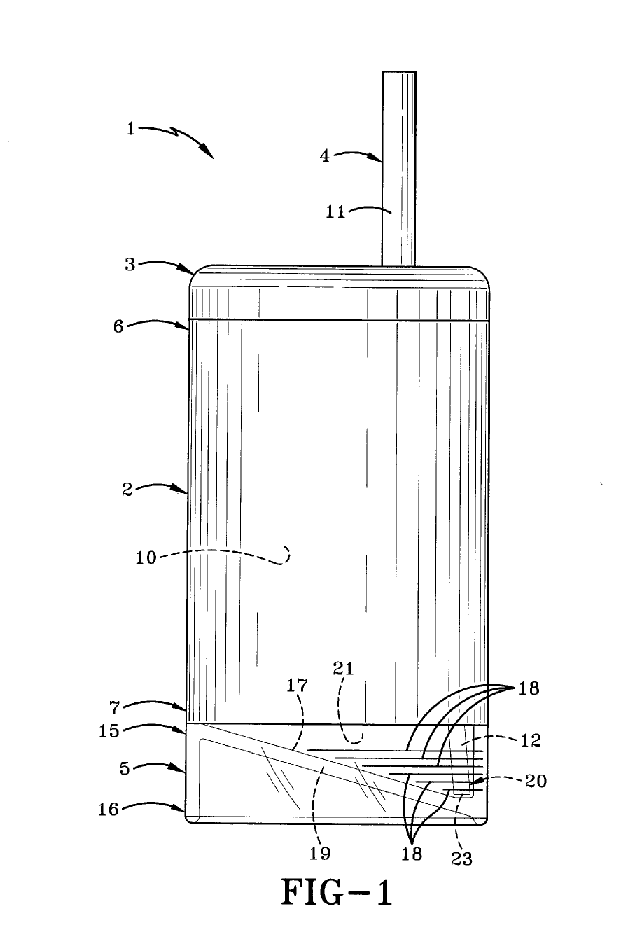

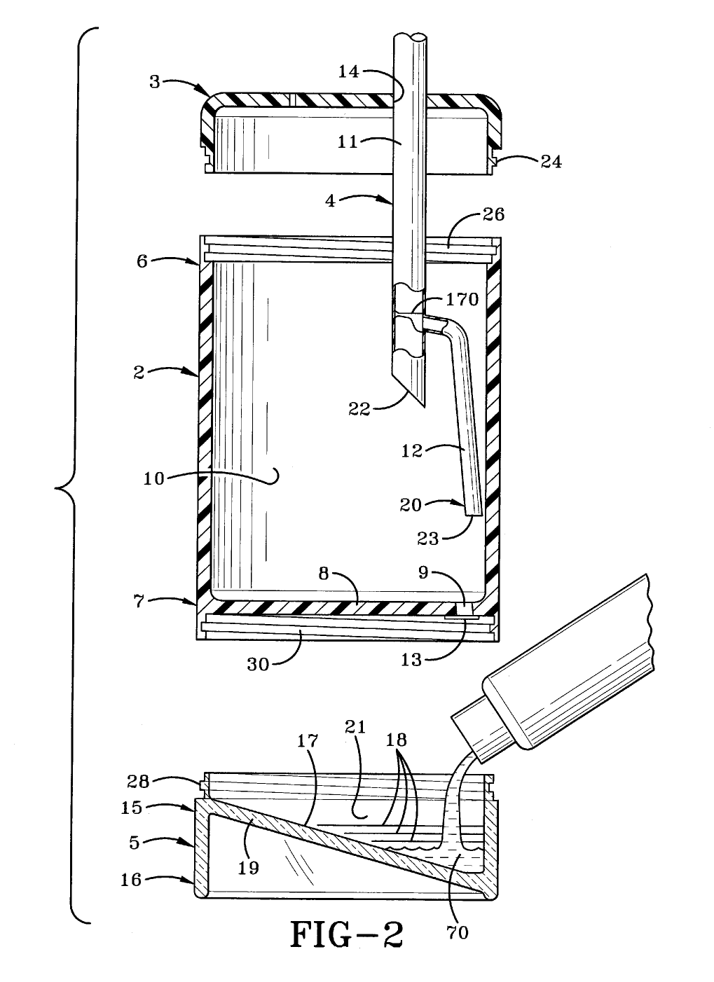

FIGS. 1-3 illustrate a first and preferred embodiment of a cup 1 used for drinking a liquid. The cup 1 of this embodiment includes a cup body 2, a lid 3, a straw 4, and a base 5. These components can be formed from different polymers of different rigidity or by other materials as understood by those of ordinary skill in the art.

The cup body 2 includes a top end 6, a bottom end 7 and a cup bottom wall 8 that form an inner chamber 10 of the cup 1. The top end 6 may include grooves 26 (e.g., threads, ridges) for screwing the lid 3 onto the top end 6 of the cup body 2. The bottom end 7 includes a bottom wall 8 with a hole 9 in it to allow a portion of the straw 4 to pass through the hole 9. In one configuration of the preferred embodiment, a one-way valve 13 can cover the hole 9 when there is no straw 4 inserted into the hole 9 to prevent leakage of liquid in the chamber 10 through the hole 9.

In the preferred embodiment, the straw 4 is formed with an upper portion 11 and a lower portion 12. The upper portion 11 has an opening 22 and the lower portion 12 has an opening 23 into which respective liquids may flow when a low pressure is created at the top of the straw 4. In the preferred embodiment, the lower portion 12 has an opening 23 with an area that is one half the area of the upper portion's opening 22. This allows for a 2-to-1consumption of the liquid in the cup body 2 with respect to medicine in the cup base 5. The upper portion 11 of the straw 4 may be tapered near the location that the lower portion 12 attaches to the upper portion 11 at a straw tap opening so that the portion of the straw above this location is of sufficient size to carry liquid injected from both hole 22 and hole 23. Those of ordinary skill in the art will appreciate the upper portion 11 and the lower portion 12 of the straw 4 can have other different cross-sectional areas to allow for different ratios of liquid-to-medicine when liquid is consumed from the cup 1.

In some configurations of the preferred embodiment, the straw 4 can have a one way-valve 170 at the junction of the upper portion 11 and a lower portion 12 of the straw. The one-way valve 170 is configured to prevent liquids that are mixed at this location from returning from the straw 4 back into chambers 10 and 21 with their respective unmixed liquids.

The lid 3 can be formed with grooves 24 (e.g., threads, ridges) that complement ridges 26 at the top end 6 of the cup body 2 to allow the lid 3 to be screwed onto and off of the cup body 2. The lid 3 includes a hole 14 to allow the upper portion 11 of the straw 4 to pass through the hole 14.

The cup base 5 is formed with an upper end 15 and a lower end 16. The upper end 15 can be formed with grooves 28 (e.g., threads) that complement ridges 30 at the bottom end 7 of the cup body 2 to allow the cup base 5 to be screwed onto and off of the cup body 2. The bottom end 16 of the cup base 5 is formed with a bottom wall 19 to form a chamber 21. When the cup base 5 is removed from the cup body 3, liquid medicine can easily be poured through the open top of the cup base 5 and into the chamber 21. The bottom wall 19 is formed with an interior tapered surface 17. The tapered surface 17 slopes generally from the upper end 15 of the cup base 5 toward the lower end 16 of the cup base toward the bottom of the straw 4. Graduation markings 18 are labeled on the cup base 5 to allow for the tracking of how much liquid medicine is added. For example, the markings 18 can include tick marks with labels indicating how many milliliters or tablespoons of medicine the cup base 5 contains.

Having described the structure of the cup 1, the use of the cup 1 is now described. The cup base 4 can be removed and liquid medicine 70 can be placed into the chamber 21 of the cup base 4. The graduated markings 18 are used to measure how much medicine 70 is placed into the cup base 5. The cup base 5 is then attached to the cup body 2. Next, a primary liquid 60 for consumption is placed into the chamber 10 of the cup body 2. The straw 4 is placed through the opening 14 in the lid 3 and the lid 3 is attached to the cup body 2. The lower portion 12 of the straw 4 is inserted through the hole 9 in the cup base 5.

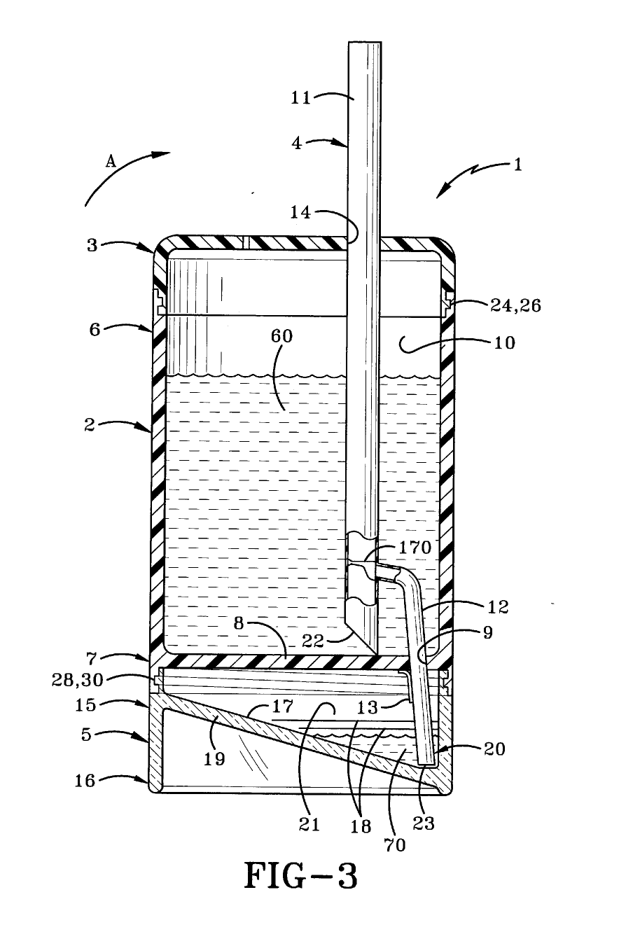

To consume the liquid 60, a person would suck on the straw 4 as normal to create a negative pressure inside the straw 4. As the negative pressure is applied to the straw 4, liquid 60 in the main chamber 10 is pulled upward through the opening 22 in the upper portion 11 of the straw and a proportional amount of medicine 70 in the medicine chamber 21 of the cup base 5 is pulled into the opening 23 in the lower portion 12 of the straw 4. As discussed above, these proportions may be based on the sizes of the openings 22, 23. As medicine 70 is consumed from the cup base 5, the tapered surface 17 of the base 5 causes remaining medicine 70 in the base 5 to slide downward toward the bottom end 20 of the straw 4 when the cup 1 is relatively level or tilted in the direction of arrow A as shown in FIG. 3. The graduated markings 18 allow one to monitor the amount of medicine 70 consumed from the cup base 5 while liquid 60 is consumed from the cup body 2. Also, the sloped surface 17 allows for medicine 70 to flow toward the markers 18 to allow for the accurate measurement of medicine 70 when the medicine chamber 21 is being filled with medicine 70.

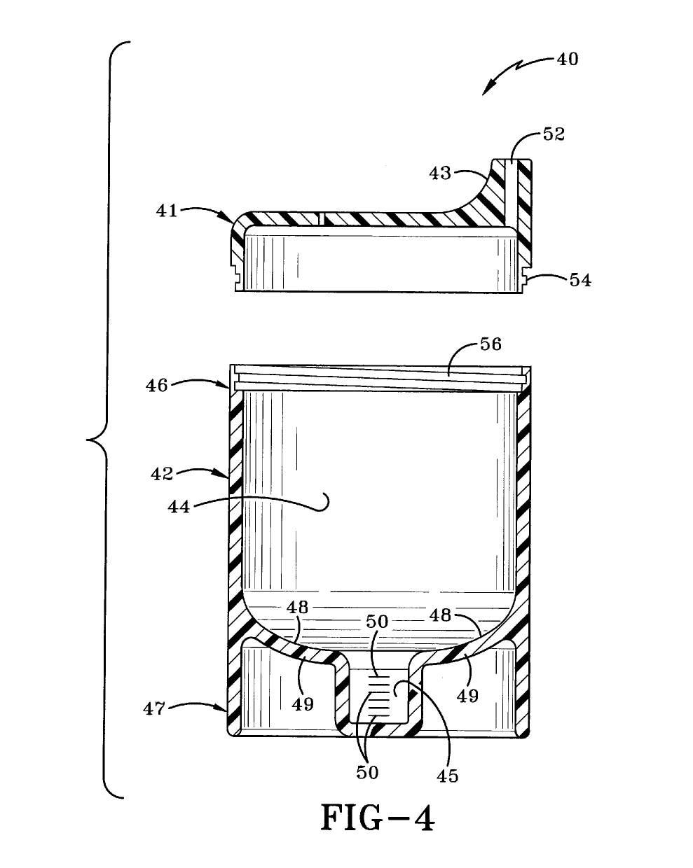

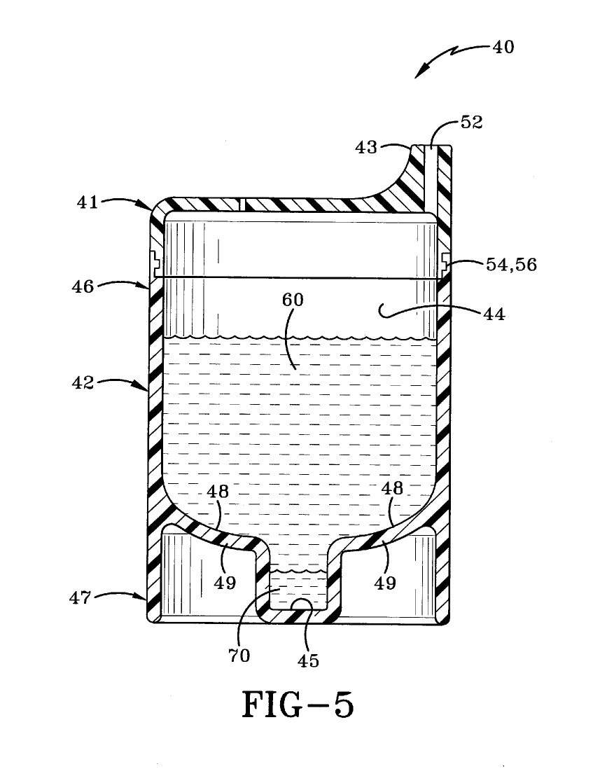

FIGS. 4-5 illustrate a second configuration of the preferred embodiment of measuring medicine added to a cup that comprises a training cup 40 (e.g., sippy cup). The training cup 40 includes a lid 41 and a main body 42. These components can be formed from different polymers of different rigidity or by other materials as understood by those of ordinary skill in the art. The main body 42 is formed with a top end 46 and a bottom end 47. The top end 46 can be formed with grooves and ridges 56 (e.g., threads) to fit with complementary grooves and ridges 54 formed on the lid 41 so that the lid 41 and main body 42 can be screwed together. Of course, the lid 41 and main body 42 can be attached together in other ways.

The lid 41 includes a spout 43 to allow a user to suck liquid from the training cup 40 through the spout 43 when a negative pressure is applied to the spout 43. The lid can also include a one-way valve 52 that allows liquid to be extracted through the spout 43 when there is a negative pressure at the spout. Liquid is prevented from exiting the spout 43 when there isn't a negative pressure at the spout 43.

The main body 42 is formed with a main chamber 44 and a medicine chamber 45. The main chamber 44 is adapted to hold a primary liquid to be consumed from the training cup 40. The medicine chamber 45 is adapted to hold a liquid medicine to be consumed with the primary liquid. The medicine chamber 45 is formed below a curved bottom surface 48 of the main chamber 44 so that liquid in the main chamber 44 flows toward the medicine chamber 45 when the training cup 40 is relatively level or resting on a level surface. This curved/tapered surface 48 causes medicine to be funneled toward and into the medicine chamber 45 when medicine is initially poured into the training cup 40. Graduation marks 50 are included on the main body 42 near the medicine chamber 45 so that the amount of medicine in the medicine chamber 45 can be quickly determined. For example, the markings 50 can include tick marks with labels indicating how many milliliters, teaspoons or tablespoons of medicine the training cup 40 contains.

The medicine chamber 45 and the curved bottom surface 48 can be formed with a forming portion 49 that forms the shape of the medicine chamber 45 and the curved bottom surface 48 that is tapered toward the medicine chamber 45. The forming portion 49 is shown for simplicity in FIGS. 4-5 as a hollow portion; however, these portions of the training cup 14 can be solid portions or hollow portions that contain insulating material.

Having described the structure of the training cup 40, the use of the sippy cup 1 is now described. Medicine 70 is initially poured into the training cup 40. The curved bottom surface 48 will cause the medicine to be funnelled into the medicine chamber 45. Graduated marking 50 on the sides of the medicine chamber 45 allow for the measurement of how much medicine 70 is in the medicine chamber 45. After the medicine 70 is in the medicine chamber 45, a primary beverage 60 is added to the main chamber 44 and mixed with the medicine. This mixture can then be consumed from the training cup 40 as other liquids would be consumed from the training cup 40. In other embodiments, the training cup 40 can be any cup, glass, or other drinking device formed with a medicine chamber 45 similar to the medicine chamber of FIGS. 4-5.

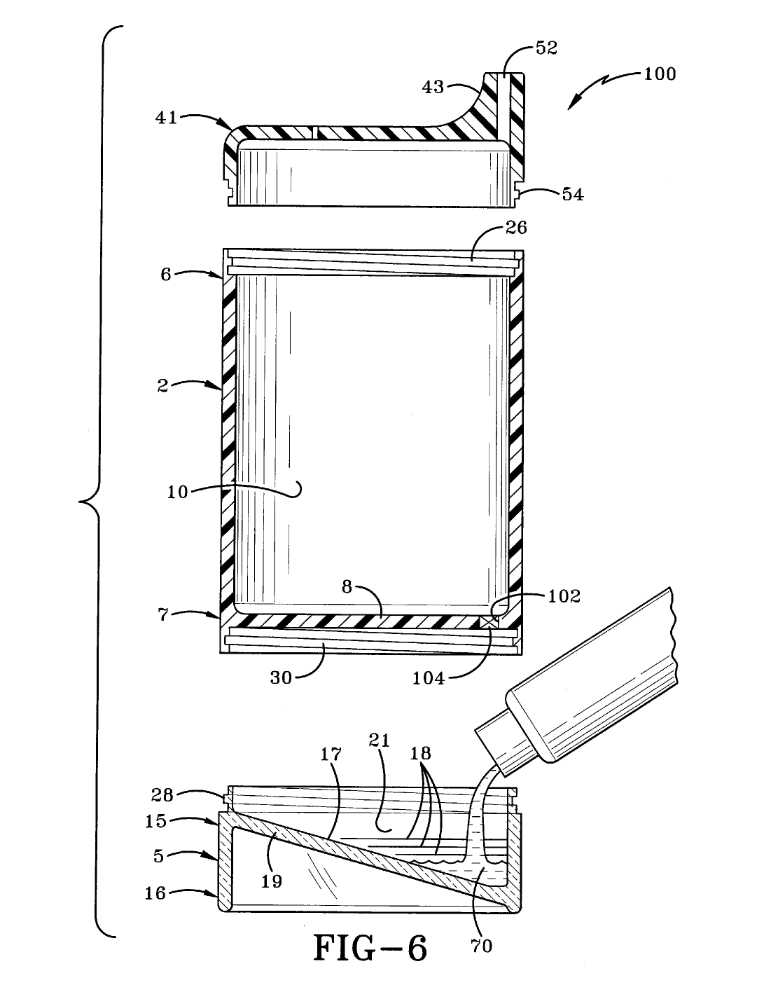

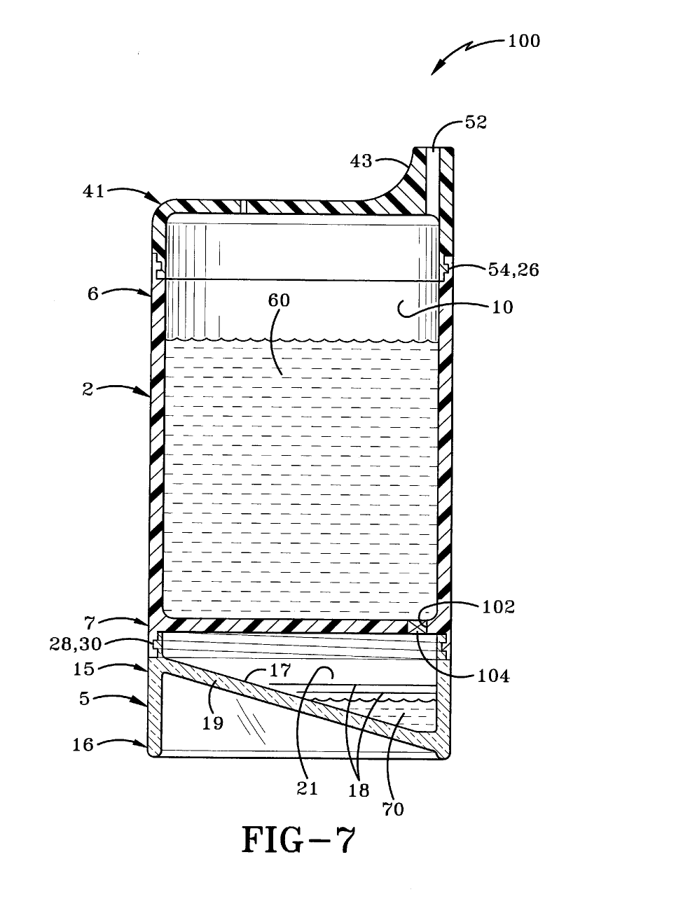

FIGS. 6-7 illustrate a third configuration of the preferred embodiment of a cup 100. The cup 100 includes a cup body 2 similar to the cup 1 of FIGS. 1-3 and a cup lid 41 similar to the cup lid of the training cup (e.g., sippy cup) of FIGS. 4 and 5. This embodiment also includes a cup base 5 that is similar to the cup base of the cup 1 of FIGS. 1-3 except that the cup base 5 of the third embodiment has a one-way a valve 104 located in a hole 102 instead of the one-way valve 13 of FIGS. 1-3 that is responsive to a straw being inserted into the base. This embodiment is similar to the preferred embodiment in that medicine can be put into the base 5 and then the base 5 and lid 41 are attached to the main body 2. In operation, a user would tip the cup 100 back so that medicine flows adjacent to the one-way valve 104. A person would then creates a negative pressure at the spout 43 that causes the one-way valve 104 to release some medicine in to the cup chamber 10 in response to the negative pressure. The third embodiment of the cup 100 allows one to determine how much medicine was ingested by comparing before and after values corresponding to liquid levels using the graduated markings 118.

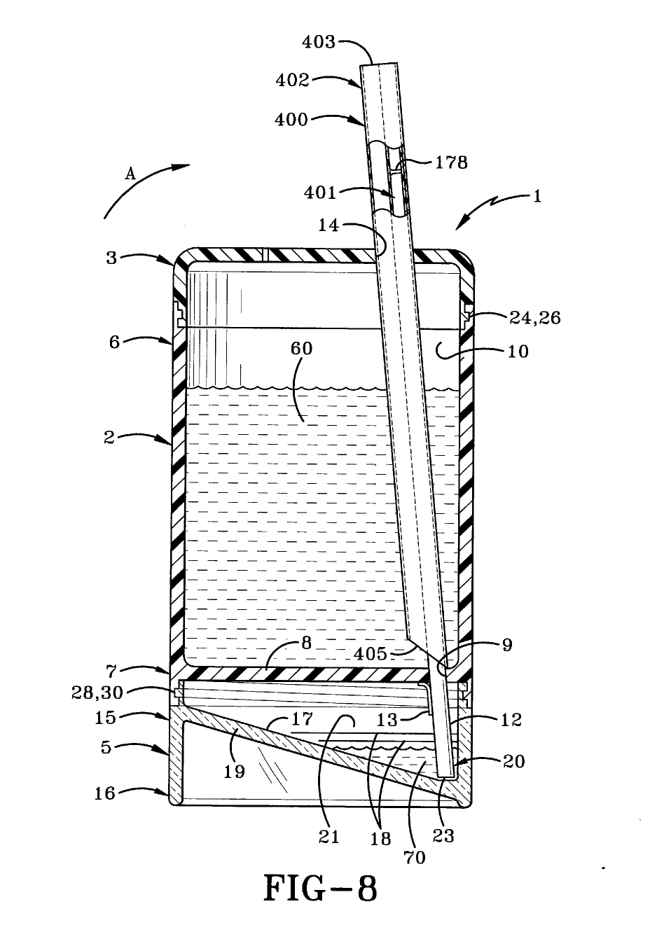

FIG. 8 illustrates another configuration of a straw 400 in use with a cup 1 that is similar to the cup 1 of FIGS. 1-3. The straw 400 is essentially a straw within a straw. The straw 400 includes a first shaft 401 and a second shaft 402 that is generally parallel to the first shaft 401. The two shafts can include some common wall surfaces that divide the two shafts. The first shaft 401 is generally circular in shape extending from a top end 403 of the straw 400 and extending downward through the hole 9 in the bottom wall 8 of the cup body 2 when the straw is inserted into the cup 1. The second shaft 402 generally extends from the top end 403 downward parallel to the first shaft 401 into the inner chamber 10 of the cup allowing the primary liquid 60 of the cup to be consumed through the straw 400. A bottom end 405 of the second shaft 402 is located near the bottom of the inner chamber 10 so that the primary liquid 60 can be nearly completely consumed when the cup 1 is being used.

Other components can be used with the straw 400. For example, a one-way valve 178 can be included within the first shaft 401 to prevent medicine from returning to the medicine chamber 21. In some configurations of the straw 400, another similar one-way valve can be included in the second shaft 402. A one-way valve 13 can be included on the cup body 2 to prevent the primary liquid 60 from mixing with the medicine 70 in the cup base 5 when the first shaft 401 of the straw 400 is not inserted into to the cup base 5. Also, the hole 9 in the bottom wall 8 of the cup body 2 can be lined with rubber or another type of sealer to prevent the primary liquid 60 from getting around the first shaft 401 mixing with the medicine 70 in the cup base 5.

The straw 400 may include other features as understood by those with ordinary skill in the art. For example, the straw 400 has been illustrated with a generally oval first shaft 401 and a second shaft 402 with an outer surface that is generally oval and that wraps around the first shaft 401; however, other suitable shapes can be used.

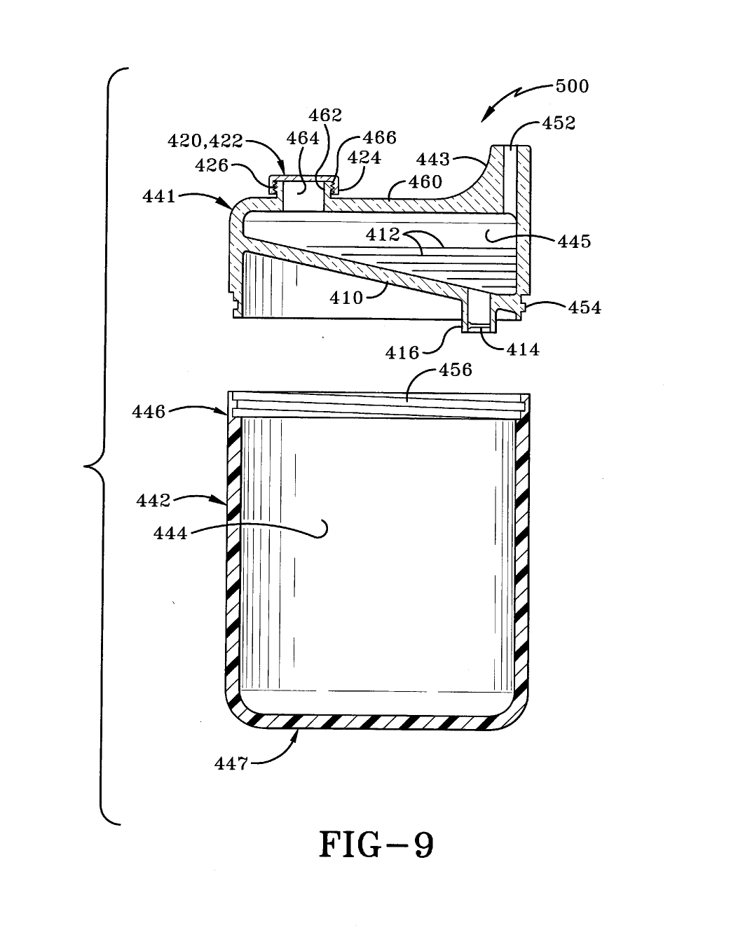

FIG. 9 illustrates an example training cup 500 that is similar to the training cup 40 of FIGS. 4 and 5. The training cup 500 includes a lid 441 and a main body 442. The main body 442 is formed with a top end 446 and a bottom end 447 located above and below a main chamber 444. Similar to the training cup of FIGS. 4 and 5, the top end 446 can be formed with grooves and ridges 456 (e.g., threads) to fit with complementary grooves and ridges 454 formed on the lid 441 so that the lid 441 and main body 442 can be screwed together.

The lid 441 includes a medicine chamber 445. The bottom end of the medicine chamber 445 is formed with a bottom wall 410 that can be sloped downward toward graduated markings 412 so that the amount of medicine in the medicine chamber 445 can be accurately measured when the training cup 500 is in use. A one-way valve 414 can be located in a straw 416 that extends from the lid 441 downward into the main chamber 444 of the cup base 442. The lid 441 can include a medicine cap 420 that can be opened to allow medicine to be added to the medicine chamber 445 and closed so that medicine will not spill from that chamber when the training cup 500 is in use. For example, the medicine cap 420 can be screwed onto and off of the lid 441 or attached to the lid 441 in other ways.

The medicine cap can include a lid top wall 422, and a cylindrical downward pointing annular wall 424 with internal upward threads 426 formed on the downward pointing annular wall 424. These threads 426 can be threaded onto external upward pointing threads 466 formed on a cylindrical upward pointing annular wall 462 formed on a top wall 460 of the lid 441.

Similar to the training cup 40 of FIGS. 4 and 5, the spout 443 of the training cup 500 allows a user to suck liquid from the training cup 500 through the a hole 452 in the spout 443 when a negative pressure is applied to the spout 443. Liquid is prevented from exiting the spout 443 when there is no negative pressure at the spout 443.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

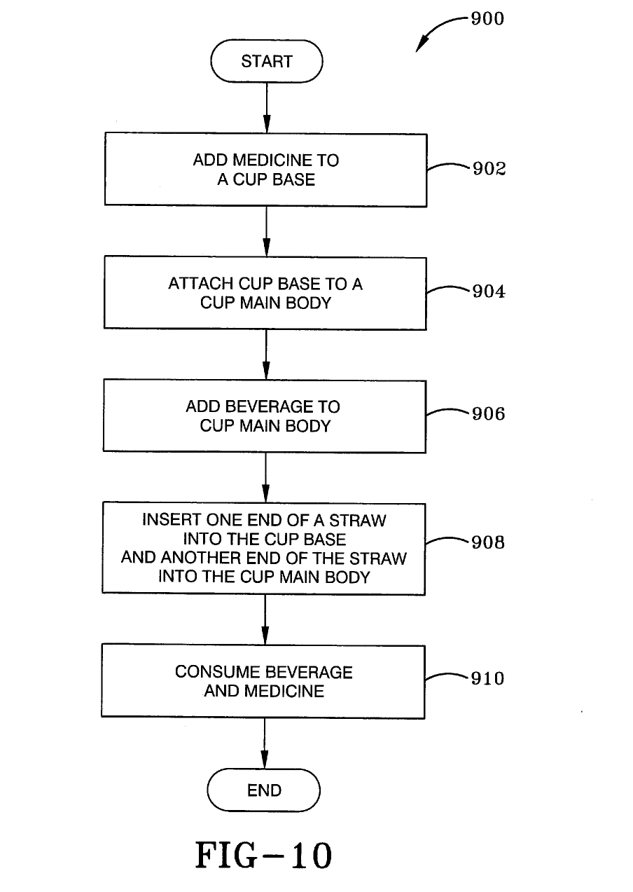

FIG. 10 illustrates a method 900 of consuming a liquid and a medicine with a cup. The method 900 begins by adding medicine to a cup base, at 902. As mentioned earlier, the cup base can contain graduated markings to indicate how much medicine was added to the base. Next, the base is attached to the main body of the cup, at 904. A beverage of choice may be added to the main body of the cup, at 906. The first end of a straw can be inserted into the cup base and the medicine, at 908. A second end of the straw is inserted into the main body of the cup, at 908, at the same time the first end of the straw is inserted into the base. After the straw has been inserted into both liquids, both liquids can be consumed, at 910, through the straw. As previously mentioned, the liquids are consumed in proportions based on the two openings of the straw in the liquids. The graduated markings allow the amount of medicine consumed to be monitored while the beverage is consumed.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A beverage cup for consuming a liquid beverage and a liquid medicine comprising:
a beverage chamber for receiving the liquid beverage;
a medicine chamber for receiving the liquid medicine; and
a control device configured to combine a portion of the liquid medicine from the medicine chamber with a portion of the liquid beverage from the beverage chamber for consumption by a user of the beverage cup.

2. The beverage cup for consuming a liquid beverage and a liquid medicine of claim 1 wherein the medicine chamber is adapted to be removed from the cup body for adding the liquid medicine to the medicine chamber, and wherein the medicine chamber is adapted to be attached to the beverage cup after the liquid medicine is added to the medicine chamber.

3. The beverage cup for consuming a liquid beverage and a liquid medicine of claim 1 further comprising:
a straw with a beverage opening with a first area and a medicine opening with a second area, wherein the medicine opening is adapted to be placed in the medicine chamber for extracting the liquid medicine and the beverage opening is adapted to be placed in the beverage chamber for extracting the liquid beverage.

4. The beverage cup for consuming a liquid beverage and a liquid medicine of claim 3 further comprising:
a cup lid with a hole, wherein the straw is configured to slide at least partially through the hole in the cup lid.

5. The beverage cup for consuming a liquid beverage and a liquid medicine of claim 4 wherein the straw further comprises:
a first elongated main straw portion configured to slide through the hole in the cup lid; and
a second elongated medicine portion configured to slide through a hole in the medicine chamber.

6. The beverage cup for consuming a liquid beverage and a liquid medicine of claim 5 further comprising:
a straw tap opening in the first elongated main straw portion, wherein the second elongated medicine portion of the straw is connected to the straw tap opening, wherein the second elongated medicine portion is configured to deliver liquid medicine from the medicine chamber through the second elongated medicine portion into the straw tap opening and into the first elongated main straw portion.

7. The beverage cup for consuming a liquid beverage and a liquid medicine of claim 6 further comprising:
a one-way valve located in the straw about the straw tap opening.

8. The beverage cup for consuming a liquid beverage and a liquid medicine of claim 5 where the first elongated main straw portion and the second elongated medicine portion are generally hollow and cylindrical in shape.

9. The beverage cup for consuming a liquid beverage and a liquid medicine of claim 5 wherein the medicine chamber further comprises:
at least one side wall and a floor that is tapered downward toward a lower tapered region adjacent the at least one side wall, wherein the second elongated medicine portion is configured to be inserted into the medicine chamber so that a bottom end of the second elongated medicine portion of the straw is adjacent the lower tapered region.

10. The beverage cup for consuming a liquid beverage and a liquid medicine of claim 1 further comprising:
graduation markings located on the medicine chamber for indicating how much liquid medicine is contained in the medicine chamber.

11. The beverage cup for consuming a liquid beverage and a liquid medicine of claim 1 further comprising:
a one-way valve in the medicine chamber configured to prevent the liquid medicine from moving from the medicine chamber into the beverage chamber when a portion of a straw is not inserted through the one-way valve.

12. The beverage cup for consuming a liquid beverage and a liquid medicine of claim 1 further comprising:
a straw further comprising:
an outer straw formed with a beverage opening;
an inner straw interior to the outer straw and formed with a medicine opening, wherein the inner straw extends outward from the beverage opening.

13. The beverage cup for consuming a liquid beverage and a liquid medicine of claim 12 wherein the outer straw is an elongated straw with a lower end and an upper end with the beverage opening formed at the lower end, wherein the inner straw is an elongated straw with a lower end and an upper end with the medicine opening formed at the lower end, wherein opening of the upper end of the outer straw is formed with an opening and the upper end of the inner straw is formed with an opening that is within the opening of the upper straw.

14. The beverage cup for consuming a liquid beverage and a liquid medicine of claim 1 further comprising:
a valve device in an upper wall of the medicine chamber to prevent medicine from flowing from the medicine chamber into the beverage chamber when there is no negative pressure created in the beverage chamber.

15. The beverage cup for consuming a liquid beverage and a liquid medicine of claim 1 further comprising:
a cup lid including a cup spout configured to create a negative pressure in the cup body when a sucking force is applied to the spout.

16. The beverage cup for consuming a liquid beverage and a liquid medicine of claim 15 wherein the cup spout, cup lid, medicine chamber and beverage chamber are configured to connect together to form a closed beverage cup so that the liquid beverage and the liquid medicine cannot spill out of the cup no matter what orientation the beverage cup is placed in as long as no negative pressure is created in the cup body.

17. The cup for consuming a liquid beverge and a liquid medicine of claim 15 wherein the cup lid, beverage chamber and medicine chamber are generally cylindrical in shape with the medicine chamber including a tapered floor that slopes toward one edge of the beverage cup.

18. The cup for consuming a liquid beverage and a liquid medicine of claim 15 wherein the medicine chamber is formed as part of the cup lid and further comprising:
a medicine chamber lid removably attached to an opening in the cup lid to allow medicine to be added to the medicine chamber through the medicine chamber lid.

19. The cup for consuming a liquid beverage and a liquid medicine of claim 18 wherein further comprising:
a straw extending from the medicine chamber in the cup lid downward toward into the beverage chamber;
a one-way valve in the straw to prevent medicine in the medicine chamber from flowing into the beverage chamber; and
a spout configured to create a negative pressure in the beverage chamber and the medicine chamber so that the beverage can be pulled into the spout and combined with some of the medicine before being consumed from the spout.

20. The cup for consuming a liquid beverage and a liquid medicine of claim 1 wherein the beverage chamber is formed above the medicine chamber, wherein the beverage chamber has a tapered bottom surface sloping toward the medicine chamber, wherein the tapered bottom surface is tapered to direct medicine poured into the training cup to first flow into the medicine chamber before beginning to fill the beverage chamber, wherein the beverage chamber and the medicine chamber are adjacent each other and configured to allow the beverage cup to be shaken and the medicine and beverage to be mixed together to create a beverage and medicine mixture.
